(19) United States
(12) Patent Application Publication
(10) Pub. No.: US 2013/0137068 A1
(43) Pub. Date: May 30, 2013

(54) METHOD OF TRANSFORMING A HUMAN BODY THROUGH ENERGY SOURCE CYCLING

(71) Applicant: Franco Carlotto, Los Angeles, CA (US)

(72) Inventor: Franco Carlotto, Los Angeles, CA (US)

(21) Appl. No.: 13/306,662

(22) Filed: Nov. 29, 2011

(51) Int. Cl. G09B 19/00

(52) U.S. Cl. 434/127

(57) ABSTRACT

The present invention diet, system, device, and method of transforming a body through energy source cycling that does not require a person to go without food to accomplish the same fat burning results. The invention requires a person to restrict carbohydrates for two to three days and then eat a normal amount of carbohydrates for one to two days. This cycle is then repeated.

### FIELD OF THE INVENTION

The invention generally relates to devices, systems, and methods for losing and controlling weight. Specifically, the invention relates to a method of transforming a human body through energy source cycling via timing and regulation of carbohydrate intake.

### BACKGROUND OF THE INVENTION

Currently, there are tens of thousands of published diets available within the United States. Despite this large number of published diets, most people still struggle to find one particular diet that actually works for them, and the shear amount of diets available have led to confusion about dieting and how to lose weight safely and effectively. Moreover, most diets are so ineffective for people that two years after beginning a diet, and initially losing weight, over 90% have either regained the weight they lost or, are heavier then than when they first started dieting.

People quit dieting for two reasons. First, the majority of diets do not provide the desired results. Second most diets are designed to be too restrictive. They deprive a body of calories, nutrients, and/or certain food choices, and as a result, the metabolism slows down to a point where it is practically impossible to lose weight.

Food restrictive diets encourage eating very small amounts of food. These diets are often called “starvation” or “mouse diets.” They are mostly based on eating fewer calories. The problem is that the body does not really think in terms of calories—but rather in terms of nutrients. One hundred calories from an apple is not the same as a hundred calories coming from candy. These diets can be very dangerous to a person's health and should be avoided at all costs. They are very hard to follow and can cause a host of health problems. Although one may experience some weight loss in the short-term, it is usually just that—short term. The body adjusts quickly to eating less food and this makes it almost impossible to lose more weight. These diets wreak havoc on a person's metabolism and health, and this is the last thing a person should do when trying to lose weight.

On the other hand, choice restrictive diets eliminate certain foods from a diet. A person following a choice restrictive diet typically over-eats certain kinds of foods and nutrients, while completely ignoring others. These extreme types of diets include things like constant low-carb diets, low fat diets, and blood type diets. Unless there is a medical condition or allergy that requires a person going on these types of diets, it is usually not a good idea to do so. Although both food and choice restrictive diets can work in the short term, they rarely work long term. While cutting calories can help people lose weight, any diet that promotes eating minimal amounts of food, or the same kinds of food, for a long period of time, doesn't typically work for the average person. Humans are simply not designed to spend their lives eating tiny amounts of the same foods. The present invention is a method that replaces overly restrictive dieting and works both in the short term and long term.

In addition to being ineffective, food and choice restrictive diets can be very harmful to the dieter. For example, being on a low or no-carb diet for a long period of time has many down sides. These include: decreased metabolism; depression; increased irritability; loss of concentration; loss of energy; loss of strength; high cholesterol; lack of fiber; vitamin deficiencies; dehydration; gastrointestinal problems; kidney disease; gallbladder disease; and heart disease.

Many diets suggest a person eat by color or by blood type, or some other such way. No matter what it is, these diets are either too flexible by suggesting a person eat according to how they feel, or they are too restrictive by allowing people to only eat certain foods for weeks, months, or even years. Whatever the case, choice restrictive diets rarely work over the long term. The problem with these “exotic diets” is that they often make people avoid foods that are perfectly healthy to eat in a balanced way. For example, many of these diets say to avoid foods like potatoes, rice, cereal and bread. However, cutting these foods out of a diet is no guarantee that weight will be lost.

In the seventies and eighties there was “high-carb mania,” where the popular diets of the day recommended eating large amounts of carbohydrates. Then, in the nineties until today, the opposite became more popular. Currently, people everywhere seem to be continuing to avoid carbohydrates for long periods of times or even indefinitely. In fact, this “low-carb mania” has swept the world and created legions of low-carb fanatics. Despite this hysteria, carbohydrates are still a necessary part of any diet. Carbohydrates act as the main source of fuel for the body and are necessary for a person to function properly. In fact, carbohydrates are the preferred food for the brain. But, not all carbohydrates are the same. Some carbohydrates are beneficial to a person's health and others are not. Most of the refined and highly processed foods, which have become staples in the modern diet, are the kinds of carbohydrates humans should avoid. This is because human bodies were never designed to imbibe in large quantities the simple sugars and unhealthy additives in processed foods today. For example, 200 years ago the average “pure” sugar intake per person was less than 20 pounds a year. Now it is about 200 pounds annually.

Carbohydrates can be defined as either complex or simple. They are defined this way based on their molecular structure. Simple carbohydrates are associated with foods that are refined, processed and unnatural. These carbohydrates have a high glycemic index value and when eaten, they rapidly increase the blood sugar levels. Simple carbohydrates are often called empty carbohydrates or unhealthy carbohydrates, as they are typically void of nutrients like fiber and vitamins. Simple carbohydrates include foods like: white sugar; candy; soft drinks; highly processed white breads; general baked goods; sugary cereals; and certain kinds of exotic fruits.

Complex carbohydrates, on the other hand, are typically unrefined, unprocessed and natural. They have a relative low glycemic index value as they come with lots of nutrients and fiber. They are digested more slowly and they do not promote the spike in insulin production like simple carbohydrates do. They are therefore often referred to as “good carbohydrates” or healthy carbohydrates. These carbohydrates are the best to eat, as they are less likely to be converted into fat. Complex carbohydrates include, but are not limited to: vegetables; oatmeal; brown rice; sweet potatoes; whole-grain products; high fiber; sugar free cereal; whole-grain pasta; and legumes.

Carbohydrates are not all bad, should never be completely eliminated from any diet, and are an important energy source for the body. The human body has the ability to store both, fat and carbohydrates. The body can store an unlimited amount of fat in fat cells, and a limited amount of carbohydrates, in the form of glycogen, in mostly the muscles and the liver. Typically, the average body can store 90 grams of carbohydrates in the liver and between 200 to 300 grams in the muscles. Once the carbohydrate storage areas are full, any excess carbohydrates a person eats are converted into fat.

Before the modern times we live in today, humans spent a great deal of time and energy gathering and obtaining food. Sometimes it was difficult to find food every day. So, in order to help us survive during times when food was scarce for more than two to three days, the human body would do two things. First, it would slow down an individual's metabolism, giving it the ability to survive on fewer calories. This is not good when trying to lose weight, but it is great for preserving energy until the next meal came along. The second thing human bodies would do in times of scarce food is tap the naturally occurring fat and carbohydrate storage areas for energy. This is why the body stores fat in an unlimited amount. It was for those times when food was not available, which of course does not really apply today.

Currently, no diet today takes advantage of how the human body empties and refills the body's energy storage systems Importantly, the regular energy source cycle where our ancestors went with less or even without food, and were forced to tap or drain their natural carbohydrate storage areas for two to three days, has a really amazing side effect: it is a very useful and efficient way to burn unwanted fat off of the body. Therefore, what is needed is a diet, system, device, and method of transforming a body through energy source cycling that does not require a person to go without certain foods for weeks to accomplish the same fat burning results.

### SUMMARY OF THE INVENTION

To minimize the limitations in the prior art, and to minimize other limitations that will become apparent upon reading and understanding the present specification, the present invention discloses a new and useful diet, system, device, and method of transforming a body through energy source cycling via regulation of carbohydrate intake.

Unlike a traditional low-carb diet that severely restricts carbohydrate consumption, the present invention requires the regulated eating of carbohydrates. The present invention regulates and/or rearranges the way carbohydrates are imbibed. It is a process where carbohydrates are eaten in a normal manner on certain days, while restricting them on other days. This “cycling” approach to eating carbohydrates is a very powerful weight loss technique because it allows a person to eat carbohydrates, naturally store them, and then burn them off. The result of following the method of the present invention is that the body will burn fat fast.

The present invention allows a person to eat carbohydrates when the carbohydrate storage areas are not full, and restricts carbohydrate consumption when the carbohydrate storage areas are full. In this way, carbohydrates that are consumed can be used efficiently as energy for the body instead of stored as fat. The constant source of carbohydrate energy available to the body results in the lack of need for fat reserves, which are quickly burned off by the body.

An important component to the method of the present invention is to have a regulated and steady source of carbohydrates to keep the carbohydrate storage areas from becoming over filled or empty. When the carbohydrate reserves are low or empty, this slows the body's metabolism and energy down, as well depriving the body from certain nutrients. Failing to eat carbohydrates prevents the body from experiencing the powerful fat burning process that happens when it is constantly being depleted and re-load.

The best carbohydrates to consume as part of the present invention are complex carbohydrates. This is because eating simple carbohydrates will quickly fill the carbohydrate storage areas and the likely excess will be converted into fat.

The preferred diet of the present invention is to periodically drain the filled carbohydrate reserves for two to three (2-3) days. Then, to eat carbohydrates normally for one to two (1-2) days. For example, a one week cycle of eating may start with limiting carbohydrates on Monday and Tuesday, eating a normal amount of carbohydrates on Wednesday, limiting carbohydrates on Thursday, Friday, and the first half of Saturday, and then eating a normal amount of carbohydrates on Saturday night and Sunday. This same cycle can then be repeated week after week. When this is done, the replenishing carbohydrates will be directed to a body's natural carbohydrate reserves and not the fat cells.

It is an object of the present invention to overcome the limitations of the prior art.

It is a further object of this invention to provide a system, diet, and method for losing weight and/or burning fat without overly restricting food consumption.

One embodiment of the present invention is a method for transforming a human body through energy source cycling, the steps comprising: ingesting a restricted amount of carbohydrates into a human body for at least two days and no longer than three days, such that a plurality of stored carbohydrates within a plurality of carbohydrate storage areas of the human body are reduced; ingesting a normal amount of carbohydrates into the human body for at least one day and no longer than two days, such that the plurality of carbohydrate storage areas are replenished with the plurality of stored carbohydrates; alternately repeating the steps of ingesting the restricted amount of carbohydrates and the normal amount of carbohydrates. Preferably, the step of ingesting the restricted amount of carbohydrates is a reduction of between 25% and 75% of the normal amount of carbohydrates. More preferably, the step of ingesting the restricted amount of carbohydrates is a reduction of 50% of the normal amount of carbohydrates. Preferably, the steps further comprise exercising for between fifteen minutes and an hour each day. The method for transforming a human body through energy source cycling may further comprise the steps of ingesting by the human body each day during at least one day and no longer than two days of ingesting the normal amount of carbohydrates: (a) three to five servings of protein, (b) a normal amount of basic carbohydrates, (c) two to four servings of vegetables and legumes, (d) a normal amount of fruits, and (e) a moderate amount of fats; and ingesting by the human body each day during the at least two days and no longer than three days of ingesting the reduced amount of carbohydrates: (a) three to five servings of protein, (b) 50% of the normal amount of basic carbohydrates, (c) two to four servings of vegetables and legumes, (d) two to four servings of one or more fruits from a northern hemisphere, (e) no servings of one or more exotic fruits, and (e) a moderate amount of fats.

Another embodiment of the invention is a method of losing weight and burning fat, the steps comprising: providing a beginner stage; wherein the beginner stage is comprised of the steps of: (a) ingesting a beginner stage restricted amount of carbohydrates into a human body for at least two days and no longer than three days, such that a plurality of stored carbohydrates within a plurality of carbohydrate storage areas of the human body are reduced; (b) ingesting a normal amount of carbohydrates into the human body for at least one day and no longer than two days, such that the plurality of carbohydrate storage areas are replenished with the plurality of stored carbohydrates; (c) alternately repeating the steps of ingesting the beginner stage restricted amount of carbohydrates and the normal amount of carbohydrates; and (d) exercising by the human body at least fifteen minutes a day; wherein the beginner stage lasts at least one month; wherein the step of ingesting the beginner stage restricted amount of carbohydrates is a reduction of 50% of the normal amount of carbohydrates. The method of losing weight and burning fat further comprises: providing an intermediate stage; wherein the intermediate stage is comprised of the steps of: (a) ingesting an intermediate stage restricted amount of carbohydrates into the human body for at least two days and no longer than three days, such that a plurality of stored carbohydrates within a plurality of carbohydrate storage areas of the human body are reduced; (b) ingesting the normal amount of carbohydrates into the human body for at least one day and no longer than two days, such that the plurality of carbohydrate storage areas are replenished with the plurality of stored carbohydrates; (c) alternately repeating the steps of ingesting the intermediate stage restricted amount of carbohydrates and the normal amount of carbohydrates; and (d) exercising by the human body at least thirty minutes a day; wherein the intermediate stage immediately follows the beginner stage and lasts at least one month; wherein the step of ingesting the intermediate restricted amount of carbohydrates is a reduction of 50% of the normal amount of carbohydrates. The method of losing weight and burning fat also comprises: providing an advanced stage; wherein the advanced stage is comprised of the steps of: (a) ingesting an advanced stage restricted amount of carbohydrates into the human body for at least two days and no longer than three days, such that a plurality of stored carbohydrates within a plurality of carbohydrate storage areas of the human body are reduced; (b) ingesting the normal amount of carbohydrates into the human body for at least one day and no longer than two days, such that the plurality of carbohydrate storage areas are replenished with the plurality of stored carbohydrates; (c) alternately repeating the steps of ingesting the intermediate stage restricted amount of carbohydrates and the normal amount of carbohydrates; and (d) exercising by the human body at least sixty minutes a day; wherein the advanced stage immediately follows the intermediate stage and lasts at least one month; wherein the step of ingesting the advanced restricted amount of carbohydrates is a reduction of between 60% to 75% of the normal amount of carbohydrates.

Another embodiment of the invention is a method of maintaining a lean and healthy body, the steps comprising: ingesting a restricted amount of carbohydrates into a human body for at least two days and no longer than three days, such that a plurality of stored carbohydrates within a plurality of carbohydrate storage areas of the human body are reduced; ingesting a normal amount of carbohydrates into the human body for at least one day and no longer than two days, such that the plurality of carbohydrate storage areas are replenished with the plurality of stored carbohydrates; alternately repeating the steps of ingesting the restricted amount of carbohydrates and the normal amount of carbohydrates; wherein the step of ingesting the restricted amount of carbohydrates is a reduction is adjusted between 25% and 75% of the normal amount of carbohydrates such that the human body maintains an optimal weight.

These, as well as other components, steps, features, objects, benefits, and advantages, will now become clear from a review of the following detailed description of illustrative embodiments, the accompanying drawings, and the claims.

### DETAILED DESCRIPTION OF THE INVENTION

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

The preferred diet of the present invention is to periodically drain the filled carbohydrate reserves for two to three (2-3) days, then to eat carbohydrates normally for one to two (1-2) days. For example, a one week cycle of eating may start with limiting carbohydrates on Monday and Tuesday, eating a normal amount of carbohydrates on Wednesday, limiting carbohydrates on Thursday, Friday, and the first half of Saturday, and then eating a normal amount of carbohydrates on Saturday night and Sunday. This cycle can then be repeated week after week. When this is done, the replenishing carbohydrates will be directed to a body's natural carbohydrate reserves and not the fat cells.

The method of the present invention alternates days whereby a person eats, and then restrict carbohydrates. This routine or cycle allows a person to drain their carbohydrate reserves, which are stored in the muscles and liver, on certain days, and reload them on others. This “drain-reload” process burns fat and allows a person to more quickly lose unwanted weight.

After draining a body of its carbohydrate reserves, a person can then eat carbohydrates with the assurance that these carbohydrates will not be converted into fat. The present invention further enhances weight loss by requiring a person to eat the right kinds of foods, especially the right kinds of carbohydrates.

On the days where a person reduces their carbohydrate intake, the persons metabolism will burn fat more efficiently and quickly.

The reason a person burns fat so quickly during the draining or restricting phase of the present invention, is that when a person starts to cut carbohydrates from the diet, the body recognizes this and tries to preserve them for as long as possible. Accordingly, while a person is depleting their carbohydrate reserves, the body is also telling their fat cells to release as much fat as possible. The body does this in order to protect its current carbohydrate storages as much as possible. This is why it typically takes between two to three days to reduce sufficiently the carbohydrates stored in the carbohydrate storage area: because the body is burning fat at the same time. In fact, this is where a body will burn the most fat—the depleting stage. Once the bodies carbohydrate storage areas are empty, the fat burning (indeed, the body's entire metabolism) slows. This is why it is important that a person should not stay on a low-carb diet for long periods of time (of more than two to three days): fat loss will drastically slow or stop.

After the draining step is complete, the carbohydrate reserves must be replenished. This is done by eating a normal amount of carbohydrates. This replenishing step will prevent a body's metabolism from slowing down, will give the body energy, and will make the person feel great. Then, once the body's carbohydrate storage areas are full, the restriction and replenishing steps can be repeated again and again, and again.

The days where a person is draining the carbohydrate reserves are referred to as carbohydrate restricted or low-carb or easy-on carb days, and the days where a person reloads the carbohydrate reserves may be referred to as normal carbohydrate, carb-allowed or carb-loading days.

Carbohydrate restricted days are designed to drain a body's carbohydrate reserves as well as burn fat. Depending on a particular person's activity levels, the draining phase of the present invention takes about two to three days and is done primarily by reducing the intake of carbohydrates. A body naturally uses stored carbohydrates and fat deposits as a source of energy to perform everyday activities. As such, not consuming the normal amount of carbohydrates will deplete a body's carbohydrate reserves Importantly, restricting carbohydrates does not mean eliminating them. On carbohydrate restricted days the basic carbohydrate intake will be reduced anywhere from 25-75% depending on whether the person wants to lose weight or maintain weight. In other words, carbohydrate restricted days are not carbohydrate elimination days. A person is supposed to eat carbohydrates every day, particularly the good, low glycemic index carbohydrates like green vegetables. What a person should do is cut down or even eliminate, on carbohydrate restricted days, carbohydrates such as whole grains, starches, exotic fruits, and foods that contain processed simple sugars; but, healthy carbohydrates should be consumed, even on carbohydrate restricted days.

In addition to using, reducing, depleting (but not emptying), and/or draining the carbohydrates stored in the form of glycogen in a body's muscles and liver through restricting carbohydrate consumption, the stored carbohydrates may be further drained by incorporating exercise into one's daily routine Importantly, exercise is not necessary for the present invention, but exercising is rarely a bad idea and is highly recommended for most people.

Generally, if a person does not exercise, carbohydrate intake on carbohydrate reduced days should be cut by 50-75%. With exercise, however, the carbohydrates should be cut by 25-50%. The more a person exercises, the faster that person is going to burn the carbohydrates stored in the body's carbohydrate storage areas. Still, unless a person exercises eight hours a day it will still take two to three days to deplete or reduce the body's carbohydrate storage. Also, as preferred, a person does not have to totally deplete the stored carbohydrates in the carbohydrate storage areas, so long as the carbohydrate intake is lowered cyclically for two to three days, the invention will promote weight loss and burn fat.

Once the body's carbohydrate reserves are reduced (almost empty is preferred), the next step of the method of the present invention is to fill the carbohydrate reserves. This is accomplished by eating a normal amount of carbohydrates for one to two days immediately after the last day of the carbohydrate restricted days. Of course, in an ideal world, these carbohydrates are the complex and healthy type of carbohydrates. On carbohydrate normal days it is still important to eat as many low glycemic carbohydrates as possible, and avoid eating high glycemic carbohydrates. This will help prevent excess insulin from being released too fast and thereby transporting the carbohydrates that have been eaten to fat cells for storage. Instead, the carbohydrates will be directed into the body's natural carbohydrate storage areas: the muscles and liver. Preferably, a carbohydrate normal day is a day to eat a healthy normal balance of carbohydrates, proteins, and fat.

In combining the carbohydrate normal and carbohydrate restricted days, the preferred week would be:
Monday—Carbohydrate Restricted—25-75% reduction in carbohydrates, depending on activity levels.
Tuesday—Carbohydrate Restricted.
Wednesday—Carbohydrate Normal.
Thursday—Carbohydrate Restricted.
Friday—Carbohydrate Restricted.
Saturday—Carbohydrate Normal or, optionally, half day Restricted.
Sunday Carbohydrate Normal. Sunday is an optional day of diet rest—where a person should be allowed to eat anything they want, within reason. Of course, results might be faster if Sunday is merely a carbohydrate normal day. What this means is that Sunday is the day to enjoy some of the “bad” carbohydrates and foods that were avoided during the week, even on the carbohydrate normal days. Sunday is the day to eat ice cream and pizza, as well as anything else desired, and it is important to do this for a couple of reasons. First, there just are not many people that can be 100% strict with their food intake 100% of the time. Everyone craves certain foods once in a while, and a few bad meals a week isn't going to kill the diet. Second, after 6 days of eating healthy, the body deserves a day off, both physically and mentally. Eating without worrying about anything is a little positive shock for the body. It reloads the body's energy levels and gives the metabolism a little kick.

Importantly, starting on Monday with two carbohydrate restricted days, is preferred because that is when it would easiest for people to accomplish the restriction and start fresh after the weekend. It should be understood that the method of the present invention may be started on any day of the week so long as the normal and restricted days are alternated as described herein.

The preferred meal plan for a carbohydrate normal day would be:

| Category | Carbohydrate Normal | Carbohydrate Restricted |
|---|---|---|
| Protein | 3-5 Servings Per Day | 3-5 Servings Per Day |
| Basic | Eat Normally (the | Cut by 50% |
| Carbohydrates | recommended daily | |
| | allowance for a person of a | |
| | particular age, gender, and | |
| | height or, to start, what a | |
| | person previously ate | |
| | before starting the steps | |
| | of the present invention). | |
| Vegetables & | 2-4 Servings Per Day | 2-4 Servings Per Day |
| Legumes | | |
| Normal Fruits | Eat Normally | 2-4 Servings Per Day |
| Exotic Fruits | Eat Normally | Avoid or eat very sparingly |
| Fat | In Moderation | In Moderation |

Regarding proteins, some good protein choices include:
Fish, such as: Salmon, Swordfish, Haddock, Yellow Tail, Halibut, and Tuna
Egg whites or substitutes
Shrimp, Lobster, and Crab
Lean Red Meat such as: Top Round Steak, Lean Ground Beef, Top Sirloin, Shank, Buffalo, Ostrich, Lean Ham
Dairy Products that are No/Low-fat and sugar-free such as: Cottage Cheese, Yogurt, Nonfat Milk, etc.
Lean Poultry such as: Chicken Breast, Turkey Breast, Lean Ground Turkey
Protein Shakes, snacks or meal replacements, such as Whey or Soy Shakes, Drinks or Bars.
Low or non-fat soy bean products
Tofu
Natural Nuts such as almonds, peanuts, etc—also contain protein
Beans such as chick peas, black beans, lentils, etc

A balanced, healthy diet preferably contains some quality protein with every meal or snack consumed. A typical body's daily protein intake should be about 0.5 grams for each pound of bodyweight. Active people, or athletes, should eat up to 1.0 gram per pound.

Basic carbohydrates are grains, wheat, and starches. Examples of good basic carbohydrates are:
Oatmeal and Barley
Potatoes, Sweet Potatoes & Yams
Squash & Pumpkin
Steamed Brown Rice & Wild Rice
Whole Wheat Products
Butternut Squash
Pasta
Beans
Corn

Good vegetable and legume choices include:
Broccoli
Asparagus
Lettuce
Onions
Cucumber
Zucchini
Tomatoes
Spinach
Mushrooms
Red/Yellow/Green Peppers
Cauliflower
Carrots
Green Beans
Peas
Artichoke
Cabbage
Celery
Butternut Squash
Cabbage
Salads

Examples of good normal fruits are:
Apples
Pears
Strawberries
Blueberries
Blackberries
Grapes
Most fruits grown in Northern climates

Examples of exotic fruits include:
Apricots
Bananas
Grapefruits
Oranges
Pineapples
Nectarines
Peaches
Melons
Papayas
Other fruits grown in southern climates

Regarding portion size, for protein, one portion is about the size of that person's palm (without the fingers). For fish, the portion size is larger. For basic carbohydrates, one portion is about the size of that person's palm (not including the area of the fingers). For vegetables and legumes, one portion is about two times the size of that person's palm. For fruits, one portion size about half the size of that person's palm. For fat, one portion of nuts and seeds is a small handful and one portion of oils is one to two Tablespoons.

Because all people are different, the method of the present invention may be adjusted to accommodate specific individual lifestyles, weight goals, and activity levels.

The preferred method of the present invention requires a person to cut all basic carbohydrates by about 50% on carbohydrate restricted days. There are two main ways to adjust the fat burning or weight loss results of the present invention. First, change the amount of exercise performed. If a person exercises every day or is extraordinarily active, then that person may want to eat more carbohydrates on the carbohydrate restricted days. The 50% approximation is a preferred baseline. However, this baseline can be adjusted up or down depending on the circumstances. On the other hand, if a person is not exercising at all the carbohydrates may be reduced (preferably temporarily) by 60% to 75%.

Second, if a person desires to lose weight, rather than maintain a healthy weight, that person may consider cutting carbohydrates by 50%-75% on the carbohydrate restricted days. Of course, exercising as much as possible will speed the weight loss effort. Regardless of the weight loss goal, it is expected that the person following the steps of the present invention would easily be able to tweak their own diet as needed for optimal results. If the person is losing weight too fast, then the total amount of carbohydrates ingested may be increased on the carbohydrate reduced days. If weight is not being lost fast enough, decrease the carbohydrates Importantly, carbohydrates should never be reduced by more than 75% of what is ingested on a normal day, and a normal amount of carbohydrates should be ingested every third or fourth day for at least a day.

The present invention is preferably implemented in stages. For example, the invention may have a beginner, intermediate, and advanced stage. These three stages are preferably implemented in order from beginner to advanced. Preferably, each of these three stages is about thirty days long. For people that are new to a fit and healthy lifestyle, it is important and most efficient to start with the beginner stage for at least one to two months.

The beginner stage, or starter method of the present invention, has a baseline of eating a person's normal foods, start making healthier choices, and exercising for at least fifteen minutes each day. The beginner stage requires the person to cut all basic carbohydrates by 50% on, for example, Monday, Tuesday, Thursday, Friday, and Saturday morning, and eat basic carbohydrates normally on Wednesday, Saturday night, and Sunday. Additionally, the person should start paying more attention to what food choices are eaten and switch slowly to healthier choices during the first couple of weeks.

The intermediate stage requires the person to make mostly healthier choices and exercise for at least thirty minutes a day. Within the intermediate stage, the person should have the same carbohydrate reduction as in the beginner stage, but actively choose healthy protein, fats, and carbohydrates.

The advanced stage requires the person to make only healthy choices, exercise for at least sixty minutes, and reduce basic carbohydrates by 60% to 75% on carbohydrate reduction days. Importantly, the person should never go below 50-75 grams/day of carbohydrates and never skip a normal carbohydrate day. But, “cheating” by eating processed, sugary, and fatty foods should be minimized The advanced stage should never be started directly as a beginner or a returner.

Unless otherwise stated, all measurements, values, ratings, positions, magnitudes, sizes, locations, and other specifications that are set forth in this specification, including in the claims which follow, are approximate, not exact. They are intended to have a reasonable range that is consistent with the functions to which they relate and that is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method for transforming a human body through energy source cycling, the steps comprising:
ingesting a restricted amount of carbohydrates into a human body for at least two days and no longer than three days, such that a plurality of stored carbohydrates within a plurality of carbohydrate storage areas of said human body are reduced;
ingesting a normal amount of carbohydrates into said human body for at least one day and no longer than two days, such that said plurality of carbohydrate storage areas are replenished with said plurality of stored carbohydrates;
alternately repeating the steps of ingesting said restricted amount of carbohydrates and said normal amount of carbohydrates.

2. The method for transforming a human body through energy source cycling of claim 1, the steps further comprising:
wherein said step of ingesting said restricted amount of carbohydrates is a reduction of between 25% and 75% of said normal amount of carbohydrates.

3. The method for transforming a human body through energy source cycling of claim 2, the steps further comprising:
wherein said step of ingesting said restricted amount of carbohydrates is a reduction of 50% of said normal amount of carbohydrates.

4. The method for transforming a human body through energy source cycling of claim 1, the steps further comprising:
exercising for between fifteen minutes and an hour each day.

5. The method for transforming a human body through energy source cycling of claim 1, the steps further comprising:
ingesting by said human body each day during said at least one day and no longer than two days of ingesting said normal amount of carbohydrates:
(a) three to five servings of protein,
(b) a normal amount of basic carbohydrates,
(c) two to four servings of vegetables and legumes,
(d) a normal amount of fruits, and
(e) a moderate amount of fats,
ingesting by said human body each day during said at least two days and no longer than three days of ingesting said reduced amount of carbohydrates:
(a) three to five servings of protein,
(b) 50% of said normal amount of basic carbohydrates,
(c) two to four servings of vegetables and legumes,
(d) two to four servings of one or more fruits from a northern hemisphere,
(e) no servings of one or more exotic fruits, and
(e) a moderate amount of fats.

6. A method of losing weight and burning fat, the steps comprising:
providing a beginner stage;
wherein said beginner stage is comprised of the steps of:
(a) ingesting a beginner stage restricted amount of carbohydrates into a human body for at least two days and no longer than three days, such that a plurality of stored carbohydrates within a plurality of carbohydrate storage areas of said human body are reduced;
(b) ingesting a normal amount of carbohydrates into said human body for at least one day and no longer than two days, such that said plurality of carbohydrate storage areas are replenished with said plurality of stored carbohydrates;
(c) alternately repeating the steps of ingesting said beginner stage restricted amount of carbohydrates and said normal amount of carbohydrates; and
(d) exercising by said human body at least fifteen minutes a day;
wherein said beginner stage lasts at least one month;
wherein said step of ingesting said beginner stage restricted amount of carbohydrates is a reduction of 50% of said normal amount of carbohydrates.

7. The method of losing weight and burning fat of claim 6, the steps comprising:
providing an intermediate stage;
wherein said intermediate stage is comprised of the steps of:
(a) ingesting an intermediate stage restricted amount of carbohydrates into said human body for at least two days and no longer than three days, such that a plurality of stored carbohydrates within a plurality of carbohydrate storage areas of said human body are reduced;
(b) ingesting said normal amount of carbohydrates into said human body for at least one day and no longer than two days, such that said plurality of carbohydrate storage areas are replenished with said plurality of stored carbohydrates;
(c) alternately repeating the steps of ingesting said intermediate stage restricted amount of carbohydrates and said normal amount of carbohydrates; and
(d) exercising by said human body at least thirty minutes a day;
wherein said intermediate stage immediately follows said beginner stage and lasts at least one month;
wherein said step of ingesting said intermediate restricted amount of carbohydrates is a reduction of 50% of said normal amount of carbohydrates.

8. The method of losing weight and burning fat of claim 7, the steps comprising:
providing an advanced stage;
wherein said advanced stage is comprised of the steps of:
(a) ingesting an advanced stage restricted amount of carbohydrates into said human body for at least two days and no longer than three days, such that a plurality of stored carbohydrates within a plurality of carbohydrate storage areas of said human body are reduced;
(b) ingesting said normal amount of carbohydrates into said human body for at least one day and no longer than two days, such that said plurality of carbohydrate storage areas are replenished with said plurality of stored carbohydrates;
(c) alternately repeating the steps of ingesting said intermediate stage restricted amount of carbohydrates and said normal amount of carbohydrates; and
(d) exercising by said human body at least sixty minutes a day;
wherein said advanced stage immediately follows said intermediate stage and lasts at least one month;
wherein said step of ingesting said advanced restricted amount of carbohydrates is a reduction of 60% to 75% of said normal amount of carbohydrates.

9. A method of maintaining a lean and healthy body, the steps comprising:
ingesting a restricted amount of carbohydrates into a human body for at least two days and no longer than three days, such that a plurality of stored carbohydrates within a plurality of carbohydrate storage areas of said human body are reduced;
ingesting a normal amount of carbohydrates into said human body for at least one day and no longer than two days, such that said plurality of carbohydrate storage areas are replenished with said plurality of stored carbohydrates;
alternately repeating the steps of ingesting said restricted amount of carbohydrates and said normal amount of carbohydrates;
wherein said step of ingesting said restricted amount of carbohydrates is a reduction is adjusted between 25% and 75% of said normal amount of carbohydrates such that said human body maintains an optimal weight.
